(19) United States
(12) Patent Application Publication
(10) Pub. No.: US 2011/0109721 A1
(43) Pub. Date: May 12, 2011

(54) DYNAMIC REFERENCE FRAME REORDERING FOR FRAME SEQUENTIAL STEREOSCOPIC VIDEO ENCODING

(75) Inventors: Seungwook Hong, San Diego, CA (US); Yang Yu, San Diego, CA (US)

(73) Assignee: SONY CORPORATION, Tokyo (JP)

(21) Appl. No.: 12/906,758

(22) Filed: Oct. 18, 2010

Related U.S. Application Data
(60) Provisional application No. 61/258,737, filed on Nov. 6, 2009.

(51) Int. Cl. H04N 13/00; H04N 7/26

(52) U.S. Cl. 348/43; 375/E07.125; 348/E13.06

(57) ABSTRACT

Encoding of video sequences for frame sequential stereoscopic video, such as from spatially distinct right and left imagers. During the encoding process, reference frames are reordered if it is determined that reordering will increase the number of macroblocks (MBs) which can be skipped from the encoded output, or to otherwise increase coding efficiency. Then encoding is completed using motion prediction and entropy encoding for frame sequential stereoscopic video in response to the ordering of the reference frames. Side-information is encoded about reference frame sequencing within the sequential stereoscopic video output allowing a decoder to properly decode the reference frames. As a result the number of skipped MBs can be dramatically increased and the number of MBs referenced during motion prediction significantly reduced.

### CROSS-REFERENCE TO RELATED APPLICATIONS

This application claims priority from U.S. provisional patent application Ser. No. 61/258,737 filed on Nov. 6, 2009, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to stereoscopic imaging, and more particularly to coding variations in frame sequential stereoscopic imaging.

2. Description of Related Art

Interest in high quality reproduction of images and video continues to increase. High definition broadcasting and reproduction devices are becoming ubiquitous. Toward supporting the efficient communication of these high-bandwidth streams, encoding standards have continued to improve, such as with H.264 and other entropy-based coding standards allowing multiple reference frames.

In recent years the ability to reproduce three-dimensional (3D) images has garnered more interest and development. In rendering a 3D image, spatially diverse frames must be captured and communicated separately to the left and right eye of the viewer. Through the years many techniques have been put forth, from the colored theatre glasses of decades ago, to current use of shutter-glasses in which each lens includes a shutter (e.g., LCD) which turns on and off so that each eye only sees its respective left or right image from a screen which is sequentially displaying both left and right images.

Regardless of the mechanism used for controlling how the images are displayed for each eye, the frame sequential method of encoding 3D video material is being widely adopted. In a traditional 2D video, sequential frames from a single spatial location are output at a given framing rate (e.g., 30 frames per second (fps)). Moving to frame sequentially encoded 3D video, the sequential frames of the output alternate between a left spatial image and a right spatial image.

One of the problems associated with frame sequential stereoscopic video is in regard to transporting the streams, as they have a high bandwidth which is not as readily “compacted” using conventional encoding standards.

Accordingly, a need exists for a system and method of encoding frame sequential stereoscopic video in a more compact form while not requiring the development of completely new 3D encoding mechanisms which are not compatible with 2D video streams. These needs and others are met within the present invention, which overcomes the deficiencies of previously developed video encoding systems and methods.

### BRIEF SUMMARY OF THE INVENTION

The present invention improves the efficiency (quality vs. bit rate) when encoding multiple diverse images (e.g., different types of video, such as spatially diverse) into the same output stream, and it is particularly well suited for encoding stereoscopic video within a frame sequential encoded output stream.

Toward improving the encoding of frame sequential stereoscopic (FSS) video, the present invention provides for selective reordering (swapping) of reference frame positions within the stream. It should be appreciated that encoding methods operate to reduce spatial and temporal redundancy within the image stream. Toward that goal, these encoding techniques reduce spatial redundancy within blocks of the same image frame, and reduce temporal redundancy between macroblocks across sequential frames of sequential capture intervals.

It should be appreciated that a video stream, also referred to herein simply as “video”, is a sequence of video frames. Each frame of the sequence comprises a still image. Playback of the video is performed at the designated framing rate, usually at a rate close to 30 frames per second (e.g., selected from conventional framing rates of 23.976, 24, 25, 29.97, 30 fps, or non-standard rates as applicable).

During encoding of FSS video, adjacent frames do not represent sequential capture intervals, but are instead spatially distinct, which significantly impacts the efficiency (compactness, or bit budget) of the encoded stream. By using selective reordering of reference frames, the present invention increases the efficiency of conventional 2D encoding mechanisms when applied to FSS video. Apparatus and methods according to the present invention can be implemented within a variety of advanced encoders, including H.264 and AVC encoders (AVC=advanced video coding), which can support multiple reference frames.

The invention is amenable to being embodied in a number of ways, including but not limited to the following descriptions.

One embodiment of the invention is an apparatus for encoding frame sequential stereoscopic video, comprising: (a) a computer configured for encoding first and second image sequences (e.g., from a left side imager and a right side imager) into a frame sequential stereoscopic video output; (b) a memory coupled to the computer; and (c) programming stored on the memory and executable on the computer for performing the steps of: (c)(i) dividing images into blocks, (c)(ii) reordering selected reference frames in response to determining if reordered reference frames would lead to improved encoding, and (c)(iii) completing motion prediction and entropy encoding for frame sequential stereoscopic video in response to ordering of reference frames including reordered reference frames. It will be appreciated that the remaining portion of the entropy encoding can be performed in any desired manner according to the encoder protocol, such as performing decorrelating blocks using transforms, quantizing the transform coefficients, and encoding the transforms into the output data.

In at least one implementation, the frame is encoded with both reordered and originally ordered reference frames and the statistics of each are compared to determine if the reference frame should be reordered in the encoding. To allow for proper and efficient decoding, side-information is encoded into the encoded video output indicating reference frame ordering.

Encoding according to this inventive apparatus and/or method can be utilized on any modern block-based video encoding system which includes programming to reduce temporal redundancy, for example video encoders for H.264, AVC encoding and similar encoders. The invention operates to increase coding efficiency, such as increasing the number of macroblocks which are skipped, and not encoded, into the frame sequential stereoscopic video output, and decreasing the number of macroblocks which are referenced per encoded frame. Advanced encoders, such as H.264, define side-information through which reference frame sequence information can be passed to the decoder, thus requiring no protocol modifications to be made for communicating sequence information to the decoder.

In at least one embodiment of the invention, it is determined if a scene cut has taken place, whereby the frame is set to an Inter-frame type. In at least one aspect of the invention, dual I-frames can be employed toward reducing quality variance of the sequential stereoscopic video output.

One embodiment of the invention is a method for encoding frame sequential stereoscopic video within a video encoder circuit configured for encoding first and second image sequences into a frame sequential stereoscopic video output, comprising: (a) dividing images into blocks; (b) reordering selected reference frames in response to determining if reordering reference frames would lead to improved encoding; and (c) completing motion prediction and entropy encoding for frame sequential stereoscopic video in response to ordering of reference frames including reordering reference frames. The reordering of selected reference frames increases the number of macroblocks which are skipped, and not encoded, into the frame sequential stereoscopic video output.

The present invention provides a number of beneficial aspects which can be implemented either separately or in any desired combination without departing from the present teachings.

An aspect of the invention is a method and apparatus for encoding frame sequential stereoscopic video at higher efficiencies.

Another aspect of the invention is the selective reordering of reference frames within a sequence of video frames to improve coding efficiency.

Another aspect of the invention is the determination on whether or not to reorder reference frames in response to comparing the encoding for an original order and at least one reordered encoding.

Another aspect of the invention provides increasing the number of skipped MBs when coding the frame sequential stereoscopic video.

Another aspect of the invention provides decreasing the number of MBs referenced per frame when coding the frame sequential stereoscopic video.

A still further aspect of the invention is that the method may be readily applied to a number of different video encoding technologies to boost their coding efficiency with regard to processing 3D video.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a sequential stereoscopic video frame sequence shown in response to interleaving left and right video frames captured by a stereoscopic imaging system.

FIG. 2A-2B is a video frame sequence shown in a typical order in FIG. 2A and in response to selective reference frame reordering of sequence ordering in FIG. 2B toward increasing coding efficiency according to an embodiment of the present invention.

FIG. 3 is a data diagram of reference index bit savings in response to reference frame reordering according to an aspect of the present invention.

FIG. 4 is a flow diagram of reference frame reordering according to an aspect of the present invention, showing an example of selecting one frame sequence for being coded, in response to testing multiple reference frame sequence configurations.

FIG. 5 is a video frame sequence depicted conventionally and after frame reordering according to an aspect of the present invention, showing the contrast between the relative numbers of macroblocks referenced and skipped.

FIG. 6 is a data table showing results from a test of reference frame reordering according to an aspect of the present invention.

FIG. 7 is a data table showing results from another test of reference frame reordering according to an aspect of the present invention.

FIG. 8-9 are graphs of peak signal-to-noise ratio (PSNR) with respect to frame number in response to increasing the number of reference frames according to aspects of the present invention.

FIG. 10 is a graph of peak signal-to-noise ratio (PSNR) with respect to frame number in response to applying selective frame reordering and the use of dual I-frames to reduce variation according to aspects of the present invention.

FIG. 11-12 are images captured of an event comparing the PSNR provided through conventional encoding in FIG. 11 with that which results in response to selective reference frame reordering in FIG. 12 according to an aspect of the present invention.

FIG. 13-14 are macroblock status diagrams showing the number of intra, forward, backward and skipped macroblocks in response to conventional encoding in FIG. 13 and selective frame reordering in FIG. 14 according to an aspect of the present invention which shows the increased number of skipped macroblocks.

FIG. 15 is a block diagram of an encoder configured for encoding left and right image data (or streams) into a frame sequential stereoscopic video stream according to an aspect of the present invention.

### DETAILED DESCRIPTION OF THE INVENTION

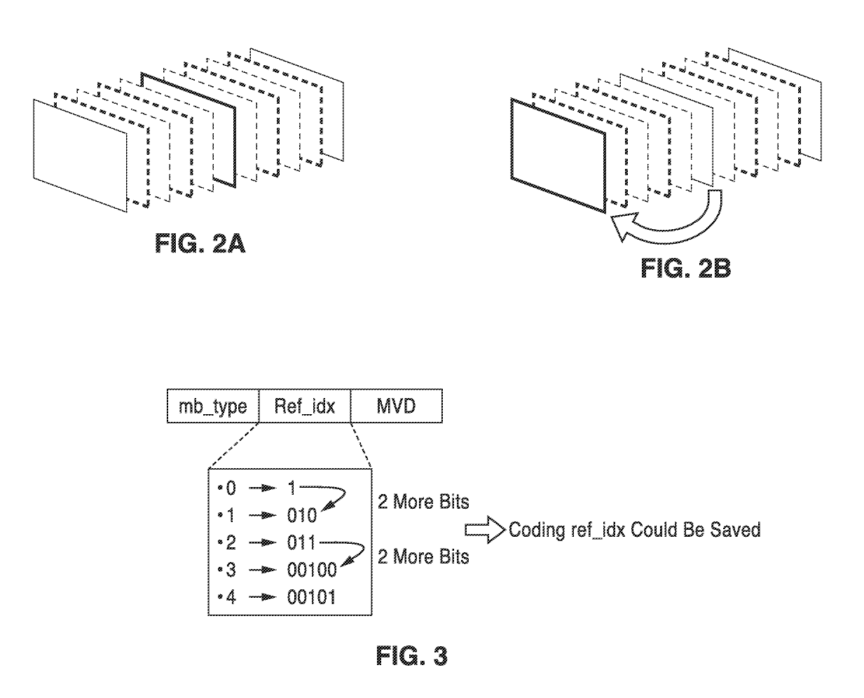

Referring more specifically to the drawings, for illustrative purposes the present invention is embodied in the apparatus generally shown in FIG. 2A through FIG. 15. It will be appreciated that the apparatus may vary as to configuration and as to details of the parts, and that the method may vary as to the specific steps and sequence, without departing from the basic concepts as disclosed herein.

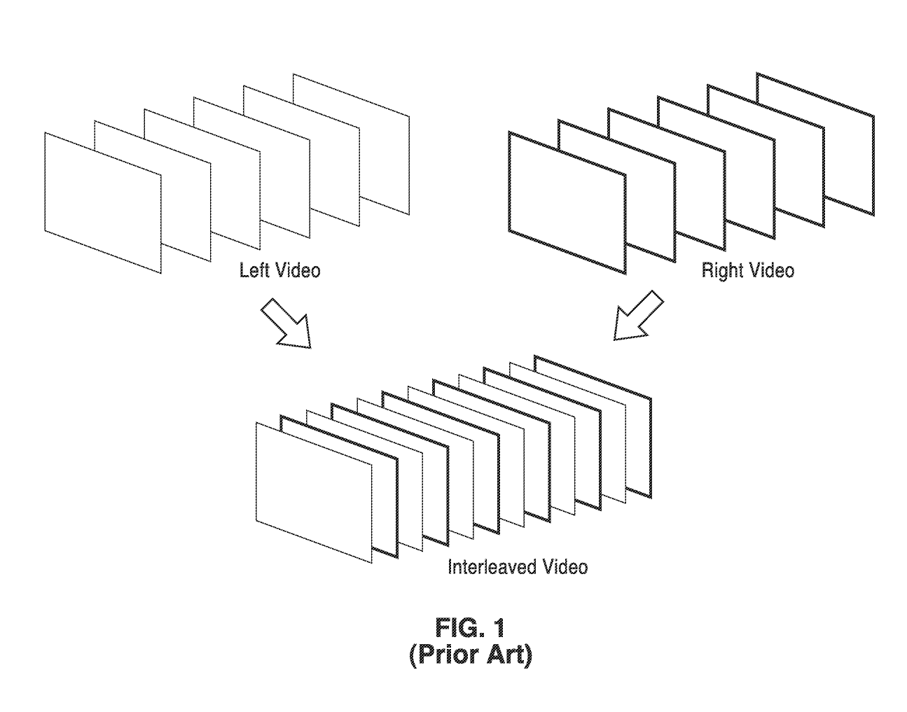

FIG. 1 illustrates a frame sequential stereoscopic video stream shown as interleaved video from left and right video sources, such as from video files or streams. The resultant interleaved video data is then encoded to reduce its bandwidth before transmission.

It will be appreciated that conventional encoders, which reduce spatial and temporal redundancy, are configured for 2D video data files. When processing interleaved video files, such as the stereoscopic video shown, the effectiveness of reducing temporal redundancy is negatively impacted in response to the presence of alternate sequential L-R frames which are spatially related and not temporally related.

These encoding problems can best be understood in response to the following paragraphs which provide some general background on typical encoding processes which have been available since the original MPEG standard, so that aspects of the present invention can be better understood. It should be appreciated that different video encoding standards differ in some regards to the following but follow a similar pattern and retain the frame encoding which describes interframe and predicted frames.

Video frames are divided into macroblocks spanning a desired number of pixels (e.g., 8×8, 16×16, 32×32 or any other desired shape and size). Each macroblock having a certain number of luminance and chrominance blocks when considering a YUV coding standard. Macroblocks are the pixel units used when performing motion-compensated compression, and blocks are typically designated in response to discrete cosine transform (DCT) compression. Frames are typically encoded in three types: intra-frames (I-frames), forward predicted frames (P-frames), and bi-directional predicted frames (B-frames).

An I-frame is encoded as a single image which is largely independently encoded without reference to past or future frames. According to one form of encoding blocks of a frame are first transformed from the spatial domain into a frequency domain using the DCT (Discrete Cosine Transform), which separates the signal into independent frequency bands. Alternatively, other forms of encoding can be performed on the blocks, such as waveform encoding. Most frequency information is in the upper left corner of the resulting blocks. After this, the data is quantized to any desired level, typically according to a bit budget, such that lower-order bits are sufficiently suppressed or ignored within that bit-budget. Resulting data is then run-length encoded, such as in a zig-zag ordering to optimize compression by increasing zero-clustering and the elimination of these clustered zeros.

A P-frame is encoded relative to a past reference frame, which may comprise either a P-frame or an I-frame. The past reference frame is the closest preceding reference frame. Each macroblock (MB) in a P-frame can be encoded either as an I-macroblock or as a P-macroblock. An I-macroblock is encoded just like a macroblock in an I-frame, while a P-macroblock is encoded as an area of the past reference frame, plus an error (entropy) term. To specify a pixel area of the reference frame, a motion vector is included (e.g., a motion vector (0, 0) indicates that the MB is in the same position as the macroblock we are encoding). Non-zero error terms are encoded, quantized and run-length coded.

A B-frame is encoded relative to the past reference frame, the future reference frame, or both frames. The future reference frame is the closest following reference frame (I or P). The encoding for B-frames is similar to P-frames, except that motion vectors may refer to areas in the future reference frames. For macroblocks that use both past and future reference frames, the two areas are averaged.

Frames do not need to follow a static IPB pattern, and each individual frame can be of any type. The order of the IPB ordering of the frames in the output sequence is rearranged in a way that a decoder can readily decompress the frames with minimum frame buffering. For example, an input sequence of IBBPBBP can be arranged into an output sequence as IPBBPBB. However, the ordering of the reference frames are still retained in the same sequence in response to conventional coding techniques.

The encoded video sequence (e.g., H.264) is an ordered stream of bits having special bit patterns marking the beginning and ending of a logical sections. Each video sequence is thus composed of a series of Groups of Pictures (GOP's), each composed of a sequence of pictures (frames). Although the present invention is described in terms of “frames” it should be appreciated that there is some overlap between the understanding of slices and frames, and the term “slice” is often used synonymously with “frame”. Technically, a frame is an independently decodable unit and there can be one or more slices per frame, or as few as one macroblock per slice, or any variation in between the two, whereby the present invention is generally applicable to both frames and slices.

The present invention selectively modifies the ordering of the reference frames, by selective reordering, when encoding a given frame to improve coding efficiency. When applied to frame sequential stereoscopic video coding, the present invention thus utilizes a combination of inter-frame and inter-view prediction. Inter-view prediction is prediction performed between the multiple views, such as predicting a right-view frame from a left-view frame. Inter-frame prediction is performed from within the same view, whether a right view or a left view, which are separated in the stereoscopic sequence by an interposing reference frame. The multi-view coding according to the present invention performs both types of prediction to take advantage of inter-view redundancies and select the best predictive reference frame which is not always the closest reference frame in the frame sequential stereoscopic video sequence. The following illustrates a simple example of performing the method on stereoscopic video data.

FIG. 2A illustrates a conventional frame sequential stereoscopic video having a plurality of reference frames. It will be seen in the diagram that in this case the most recent reference frame (to the right) references back to the prior two reference frames.

FIG. 2B illustrates an example in which the first and second reference frames are reordered, whereby the third reference frame only need refer back to the second reference frame.

FIG. 3 shows an example of reference index coding (ref_idx) within a portion of block data which depicts a macroblock type indicator (mb_type) and motion vector difference (MVD). The diagram illustrates the use of extra bits for indicating the ordering of the reference frames.

It will be appreciated that the present invention can be more readily applied to advanced encoders, such as H.264, which allow reference to be made to multiple frames, so that a frame may be specified with each macroblock. Application of the invention to encoders which refer to only a single reference frame requires adding a mechanism for reference frame selection so that the decoding can be properly performed.

It should also be appreciated that advanced video encoding is typically performed as an off-line, non-real-time, process, although with sufficient processing resources the present invention can be implemented to perform on-line real-time encoding.

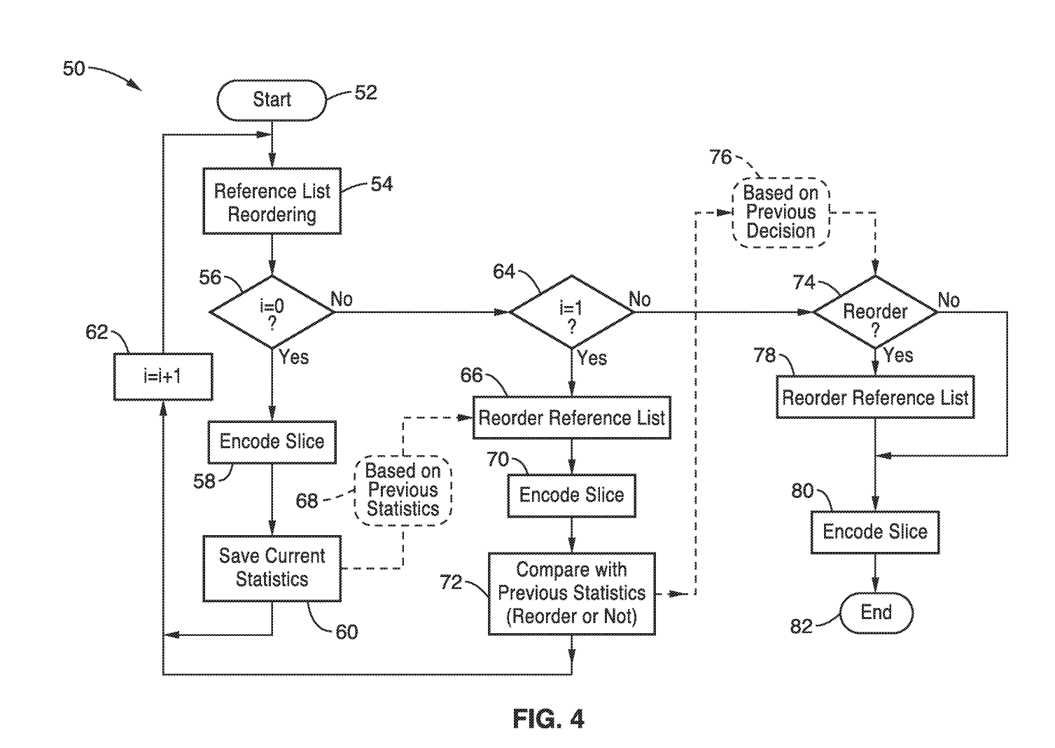

FIG. 4 illustrates an example embodiment 50 of selective reference frame reordering according to the invention. In this example embodiment, encoding is performed according to a first ordering in steps 54-60, a second ordering in steps 66-72, and then a comparison is made whether a reference frame reorder is desirable, whereby the frame is encoded again in steps 78-80.

The method starts 52 at an initial condition and the reference list is set according to a first order 54. Detected as a first pass in step 56 the frame is encoded 58 and statistics determined and saved 60. Pass index is incremented 62 and the reference list is reordered 54. As this is not the original pass (i=0) as detected at step 56, a check is made 64 for the second pass (i=1) and being true, the reference list is reordered 66 based on data from the previous frame encoding 68.

Then the frame is again encoded 70 and a comparison performed 72 with the previous statistics to determine whether a reference reorder would be beneficial or not. It should be appreciated that this comparison can be performed on any desired number or combination of factors, including but not limited to increasing the number of skipped macroblocks (e.g., skipped in the encoded output), fitting cost constraints, increasing SNR, and so forth.

Pass index is incremented again 62 and the reference list ordered again with processing branching (based on i=2) to step 74 in which the comparison data 76 is used to determine whether a reference list reordering is to be performed. A reference frame reordering is performed in step 78 if beneficial, and the frame is encoded in step 80 and encoding ends for the frame at step 82.

It should be appreciated that the flowchart of FIG. 4 and the associated description above is provided by way of example and not by limitation. One of ordinary skill in the art will appreciate that the teachings of the present invention can be utilized to select if and how reference frames are reordered according to any desired form of program execution. It should be appreciated that more than two reference frame positions can be considered when comparing statistics for reordering, while the comparison can be performed on the basis of a number of encoded characteristics, or combination thereof. For example, the comparison may be configured to minimize the bit cost of the encoded video at the given quantization level, or may make other tradeoffs in relation to encoding/decoding overheads, peak signal to noise, or other desired characteristics which can be compared in relation to the reordered and original order frames.

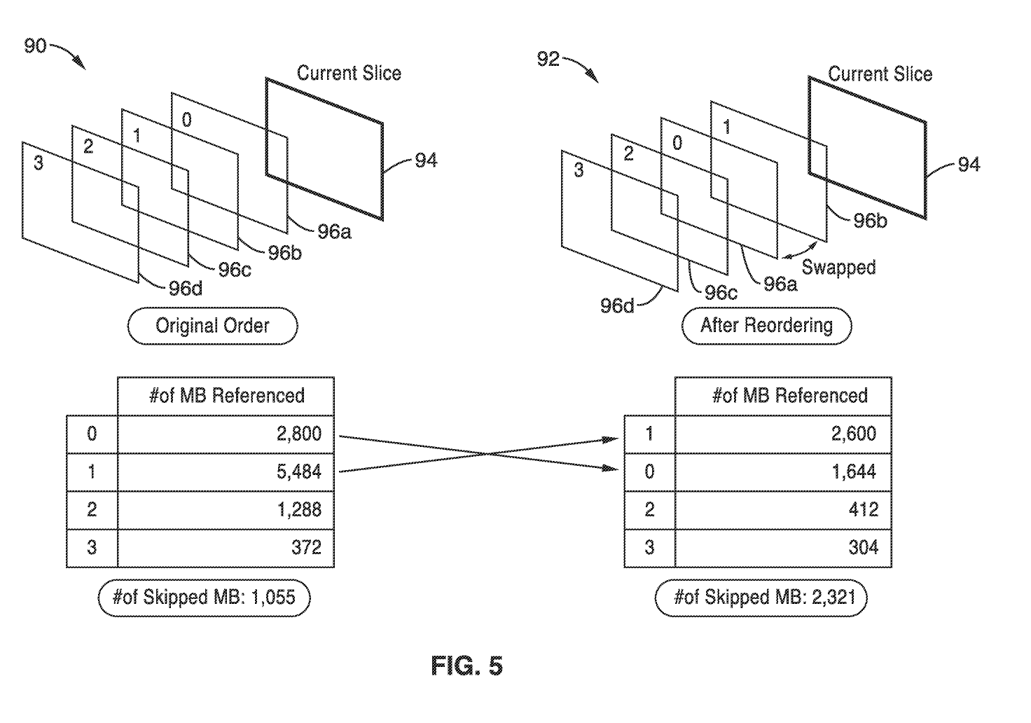

FIG. 5, in its upper portion, illustrates a plurality of reference frames 96a-96d in relation to a current frame 94, both before reordering 90 and after reordering 92. In the lower portion of FIG. 5 are shown results comparing the number of MBs referenced during the encoding process in relation to each of the reference frames. Before reordering it was found that reference frame 0 referred to 2,800 MBs, reference frame 1 referred to 5,484 MBs, reference frame 2 referred to 1,288 MBs, and reference frame 3 referred to 372 MBs. This contrasts significantly with the results after reference frame reordering, in which it was found that reference frame 0 referred to 2,600 MBs, reference frame 1 referred to 1,644 MBs, reference frame 2 referred to 412 MBs, and reference frame 3 referred to 304 MBs. Accordingly, the total number of MB references is decreased from 8944 down to 4960 showing a significant decrease in overhead.

In addition, the number of skipped macroblocks was improved from 1,055 before being reordered to 2,321 after reordering. It will be appreciated that skipped MBs need not be coded as they are so similar (e.g., no motion, panning, or zooming is apparent between frames) whereby the increased number of skipped MBs lead to a direct reduction in the number of bits generated for the encoded output. It should be appreciated that the reference frames may be reordered in any desired order, while multiple reordering is supported as well, such as 3,2,1,0→3,2,0,1→2,3,0,1, according to the teachings of the present invention.

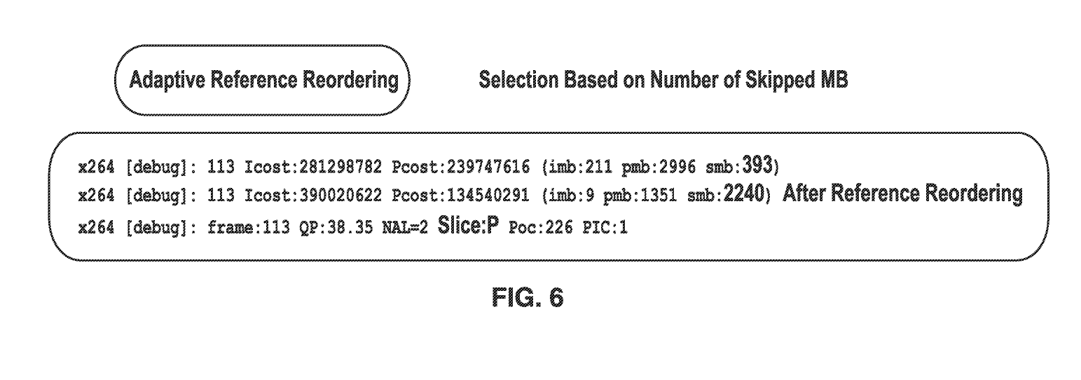

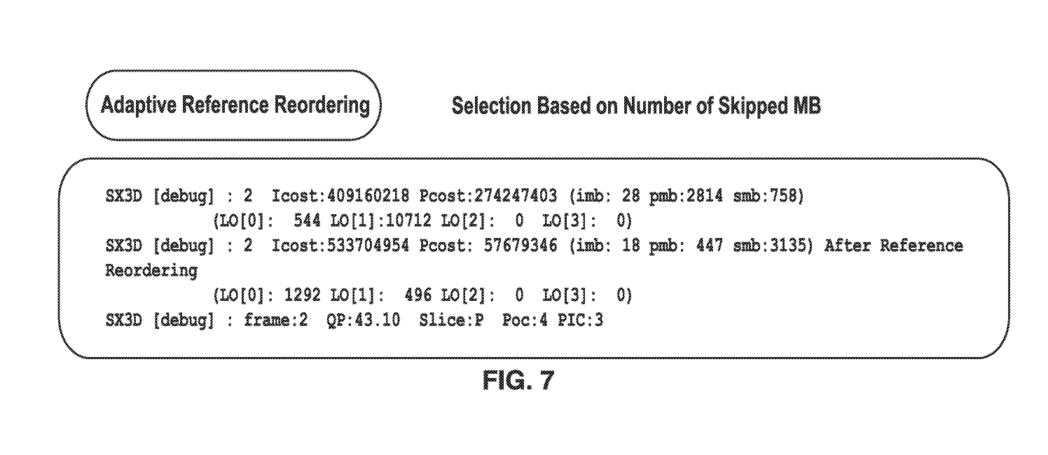

FIG. 6 and FIG. 7 depict results generated from tests using encoding related to H.264. On the first line of FIG. 6 is it seen that without reference frame reordering the encoding of frame 113 has an intra-frame cost (Icost) of 281298782 for its bit-budget, and a predictive-frame (Pcost) of 239747616. In addition, the composition of macroblocks comprised 211 intra MBs (imb), 2996 predictive MBs (pmb), and 393 MBs which were skipped (smb). On the second line of FIG. 6 the results for frame 113 are shown after selective reference frame reordering according to the present invention. In the reordered case the Icost increased to 390020622, while Pcost dropped to 134540291. Encoding resulted in only 9 intra MBs (imb), 1351 predictive MBs (pmb), within a very significantly increased 2240 skipped macroblocks.

FIG. 7 depicts another test performed on an adaptive scene cutting technique. In this test it is seen that without reordering, reference frame 2 was encoded at an intra-frame cost (Icost) of 409160218 for its bit-budget, and a predictive-frame (Pcost) of 274247403. In addition, the composition of macroblocks comprised 28 intra MBs (imb), 2814 predictive MBs (pmb), and 758 MBs which were skipped (smb). The MB references per frame are seen in this case for reference frame 0 (LO[0]) as 544, for frame 1 (LO[1]) as 10712, for frame 2 as (LO[2]) as 0, and for frame 3 as (LO[3]) as 0.

The second line of FIG. 7 depicts results for frame 2 which are shown after selective reference frame reordering according to the present invention. In the reordered case, the Icost slightly increased to 533704954, while Pcost dropped significantly to 57679346 (about one-fifth of its former value). Encoding resulted in 18 intra MBs (imb), 447 predictive MBs (pmb), and a very significantly increased 3135 skipped macroblocks. The MB references per frame are seen in this case for reference frame 0 (LO[0]) increasing from 544 to 1292, for frame 1 (LO[1]) significantly decreasing from 10712 to 496, while frame 2 (LO[2]) and frame 3 (LO[3]) remain 0 for this encoding situation. Quality can be seen as QP: 43:10 with slice type as P, POC coding type as 4 and PIC parameter set at 3.

In considering the extra bit overhead cost from inter-frame prediction, if it assumed that two bits per macroblock are added for reference frame selection, then 2 bits*8000 MB/frame=16,000 bits, or 2,000 additional bytes/frame. However, should be readily appreciated that this cost is very meager in comparison with decrease in MBs which must be coded, as seen by the increased number of skipped macroblocks. At least one embodiment of the present invention is directed at minimizing the cost of inter-frame prediction, whereby the saved bits are used for improving the quality of video within a given bit budget for the encoded video.

In development of the present invention, it has been recognized that additional or alternative mechanisms can be utilized toward increasing coding quality and/or efficiency for frame sequential stereoscopic video. These will be briefly discussed and used as a point of comparison with the reference frame reordering technique of the invention.

One means for enhancing coding of the frames is to increase the number of reference frames used, thus providing increased opportunity for the references. It should be appreciated that the number of reference frames is limited by level (e.g., level 4.1 and 4.0=12 MB for Maximum Decoded Picture Buffer size (MaxDPB)).

Another mechanism involves the reduction of quality variance by using dual I-frames which benefit both the left and right encoded image.

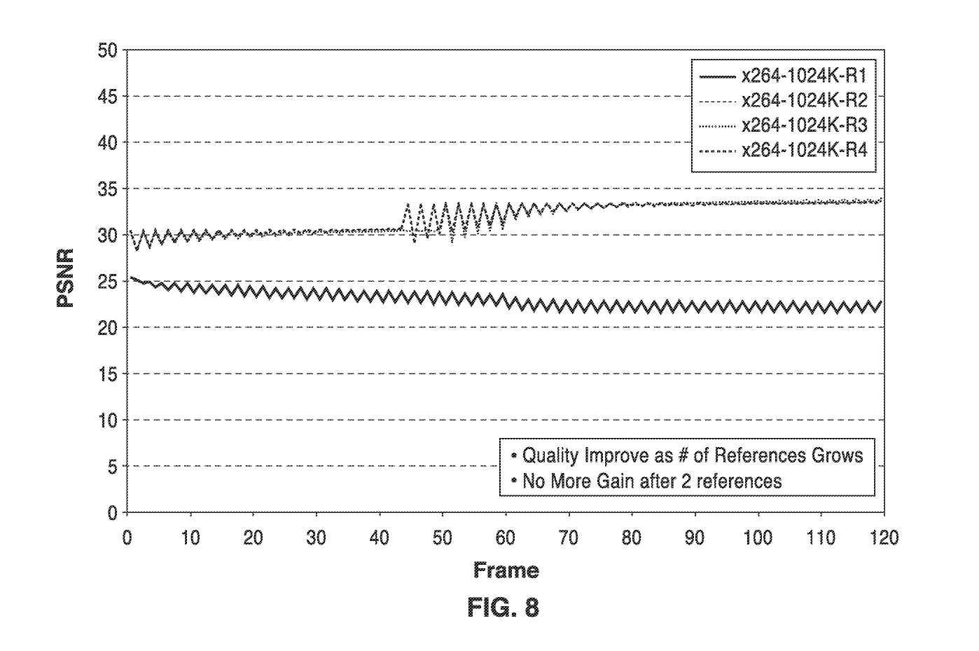

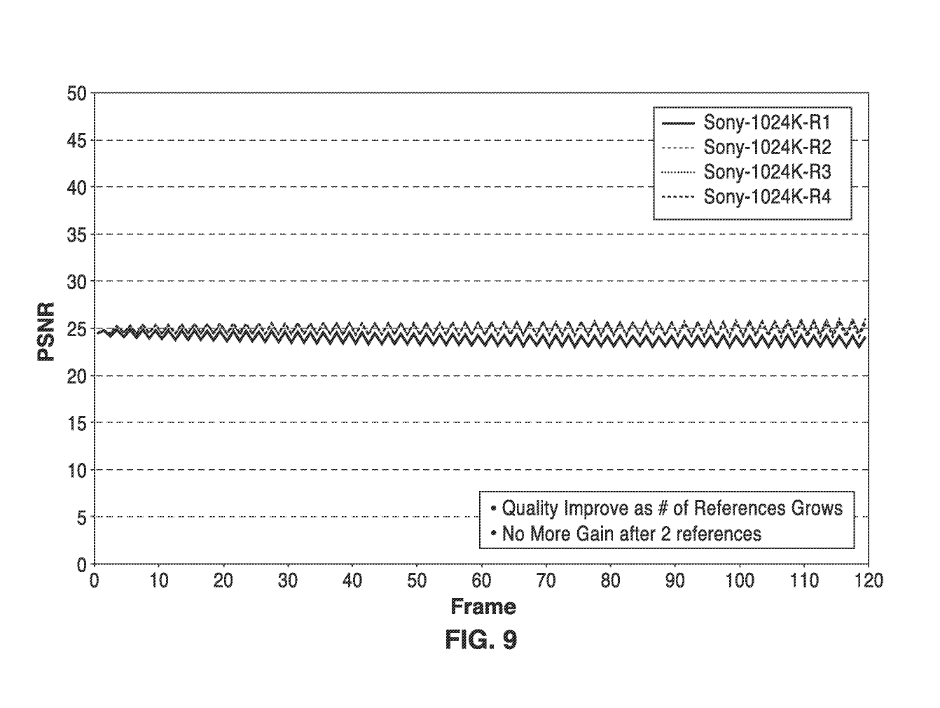

FIG. 8 and FIG. 9 depict results in response to increasing the number of reference frames for a form of h.264 encoding and for a Sony encoding format respectively. It can be seen that basically no more gain is achieved after two references. It will be seen that the corrected PSNR reaches toward 32 for x.264 and 25 for a Sony encoding technique on which this was utilized.

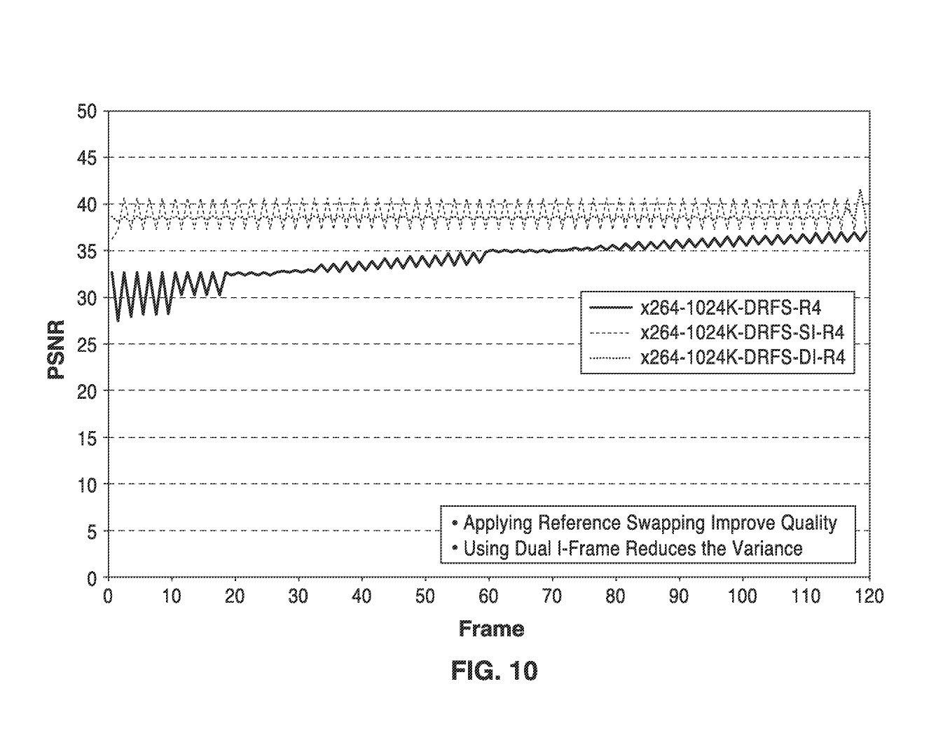

FIG. 10 represents results from performing dynamic reference reordering according to an aspect of the invention. A first trace in the graph depicts original order operation, with PSNR rising from around 30 to about 37. A second trace depicts the result with reference frame reordering with PSNR remaining centered about 38. A third trace depicts how the PSNR is smoothed in response to adding dual I-frames to the reference frame reordering method.

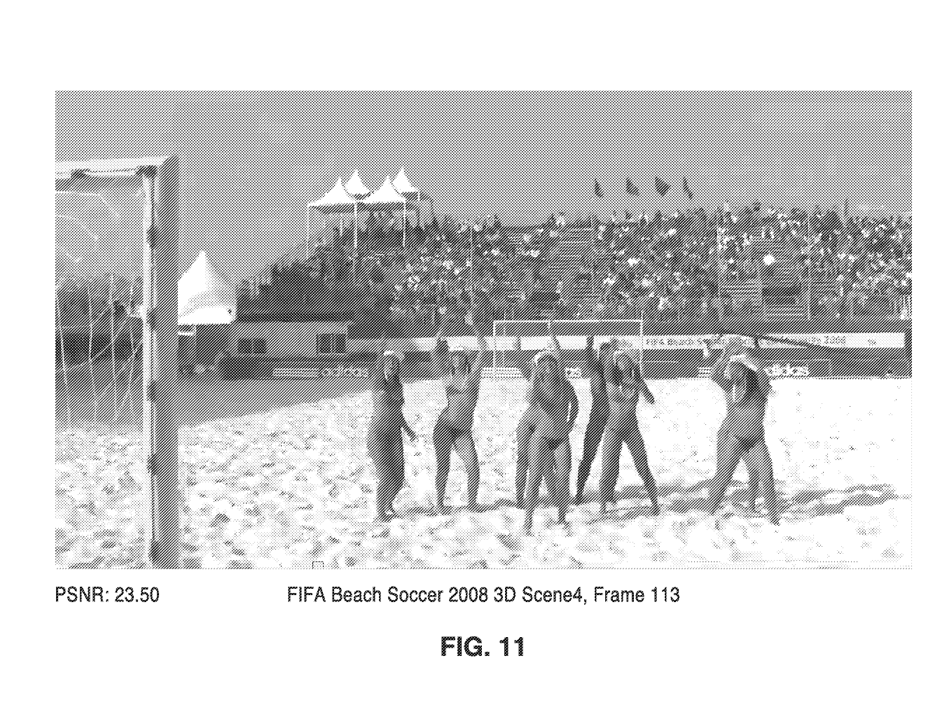

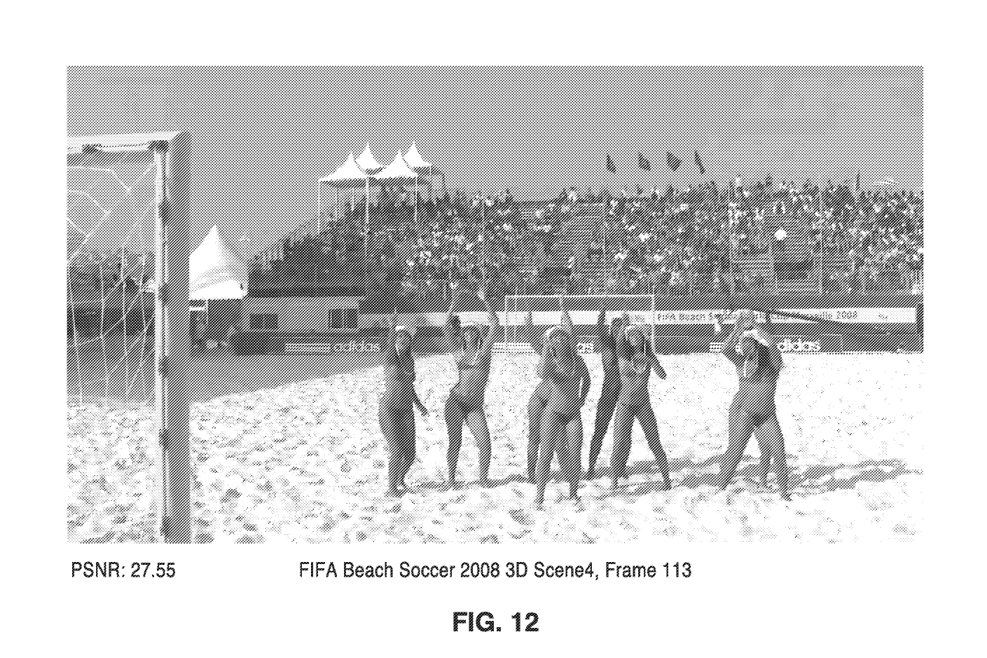

FIG. 11 and FIG. 12 are images which depict comparisons of frame 113 without reference frame reordering in FIG. 11 having a PSNR of 23.50 and 27.55 in FIG. 12 which utilizes the reference frame reordering of the invention.

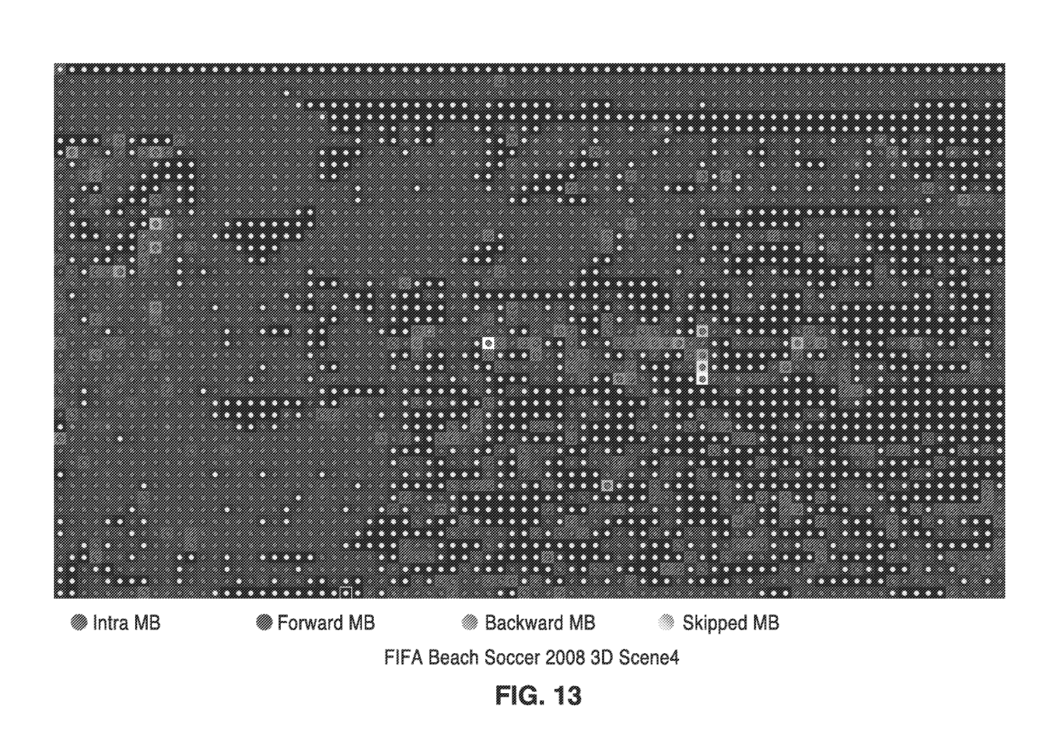

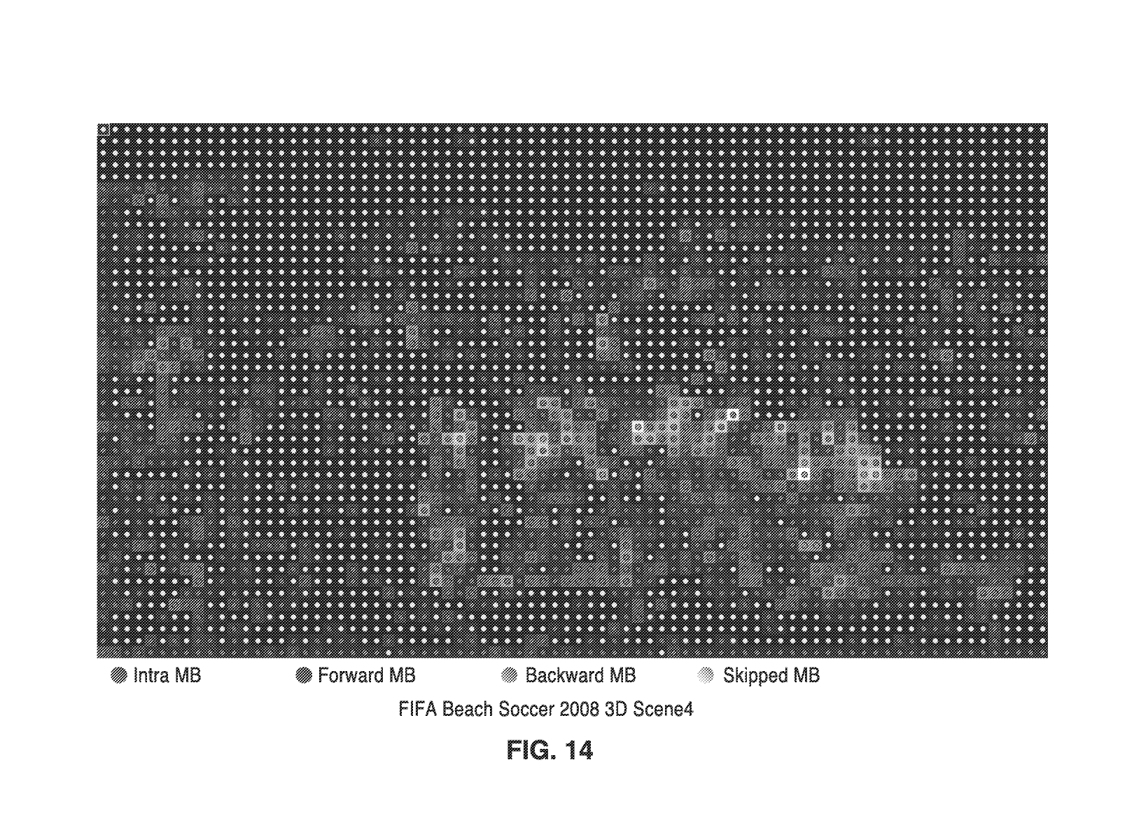

FIG. 13 and FIG. 14 are graphs of macroblock types, including intra MB, forward MB, backward MB, and skipped MB, within the images shown in FIG. 11 and FIG. 12, respectively. The vastly increased number of skipped MBs in response to selective reference frame reordering can be readily discerned in FIG. 14.

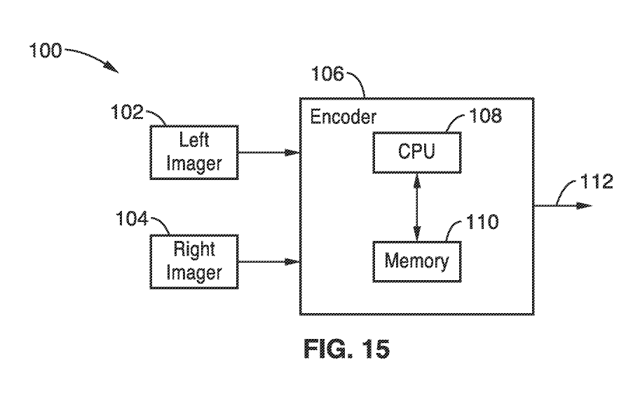

FIG. 15 illustrates an example embodiment 100 of a simple stereoscopic encoding apparatus receiving image data from left imager 102, and right imager 104 (or equivalent image data sources) within a circuit 106 configured for encoding of the stereoscopic image data. Encoding is performed in response to the use of at least one computer (central) processing unit (CPU) 108 working in combination with memory 110 to execute programming from memory upon processor 108. It should be appreciated that the encoding apparatus can include any number of processors as well as any desired additional hardware acceleration circuits without departing from the teachings of the present invention. The programming performs the video encoding steps, including the selective reordering of reference frames, and generates an encoded output 112.

During decoding, it should be appreciated that data within the encoded video indicates which reference frame is to be used for each of the macroblocks.

It should be appreciated that the present invention can also be utilized for performing predictions on video having more than one image per frame, for example in side-by-side and top-and-bottom imaging. In a side-by-side image the right and left images are contained in the left and right portions of the same frame, similarly in top-and-bottom imaging the left and right images are contained in the upper and lower portions of the frame. It will be appreciated that although the multiple views in the same frame sequential video are described as being from left and right views, these can be from any desired multiple vantage points. Using the multi-view prediction, it will be appreciated that the range of motion vectors should expand.

It should be fully recognized that an encoder and decoder configured according to the present invention can be utilized for processing frame sequential stereoscopic video as still be used for processing conventional (non-stereoscopic) video, because the reference frame reordering is only performed selectively when it provides a coding benefit.

From the description herein it will be appreciated that the present invention can be embodied in various ways, and has various modes and features, which include, but are not limited to, the following:

1. An apparatus for encoding frame sequential stereoscopic video, comprising: a computer configured for encoding first and second image sequences into a frame sequential stereoscopic video output; a memory coupled to said computer; and programming stored on said memory and executable on said computer for performing steps comprising: dividing images into blocks; reordering selected reference frames in response to determining if reordering reference frames would lead to improved encoding; and completing motion prediction and entropy encoding for frame sequential stereoscopic video in response to ordering of reference frames including reordered reference frames.

2. An apparatus as recited in embodiment 1, wherein said entropy encoding comprises decorrelating blocks using transforms, quantizing the transform coefficients, and encoding the transforms into the output data.

3. An apparatus as recited in embodiment 1, wherein said programming performs the step comprising determining if a scene cut has taken place and setting the frame to an I-type.

4. An apparatus as recited in embodiment 1, wherein said programming performs the step comprising using dual I-frames toward reducing quality variance of the sequential stereoscopic video output.

5. An apparatus as recited in embodiment 1, wherein a frame is encoded with both reordered and originally ordered reference frames and the statistics of each compared to determine if the reference frame should be reordered in the encoding.

6. An apparatus as recited in embodiment 1, wherein said encoding apparatus comprises an encoder adapted for encoding video according to the AVC or H.264 encoding standard.

7. An apparatus as recited in embodiment 1, wherein said reordering selected reference frames in said apparatus increases the number of macroblocks which are skipped, and not encoded, into the frame sequential stereoscopic video output.

8. An apparatus as recited in embodiment 1, wherein said reordering selected reference frames in said apparatus decreases the number of macroblocks which are referenced per frame.

9. An apparatus as recited in embodiment 1, wherein said first and second image sequences are captured in response to image capture from a left side imager and a right side imager.

10. An apparatus as recited in embodiment 1, wherein said programming performs the step comprising encoding information about reference frame sequencing within the sequential stereoscopic video output allowing a decoder to properly decode the reference frames.

11. An apparatus for encoding frame sequential stereoscopic video, comprising: a computer configured for encoding first and second image sequences into a frame sequential stereoscopic video output; a memory coupled to said computer; and programming stored on said memory and executable on said computer for performing steps comprising: dividing images into blocks; reordering selected reference frames in response to determining if reordering reference frames would lead to improved encoding in response to increasing the number of skipped macroblocks, increasing PSNR, and/or fitting bit cost constraints; completing motion prediction and entropy encoding for frame sequential stereoscopic video in response to ordering of reference frames including reordered reference frames, by uncorrelated blocks using transforms, quantizing the transform coefficients, and encoding the transforms into the output data; and encoding side-information about reference frame sequencing within the sequential stereoscopic video output allowing a decoder to properly decode the reference frames.

12. An apparatus as recited in embodiment 11, wherein said programming performs the step comprising using dual I-frames toward reducing quality variance of the sequential stereoscopic video output.

13. An apparatus as recited in embodiment 11, wherein a frame is encoded with both reordered and reference frames as originally ordered and the statistics of each compared to determine if the reference frame should be reordered in the encoding.

14. An apparatus as recited in embodiment 11, wherein said encoding apparatus comprises an encoder adapted for encoding video according to the AVC or H.264 encoding standard.

15. An apparatus as recited in embodiment 11, wherein said reordering selected reference frames in said apparatus increases the number of macroblocks which are skipped, and not encoded, into the frame sequential stereoscopic video output, and/or decreases the number of macroblocks which are referenced per frame.

16. A method of encoding frame sequential stereoscopic video within a video encoder circuit configured for encoding first and second image sequences into a frame sequential stereoscopic video output, comprising: dividing images into blocks; reordering selected reference frames in response to determining if reordering reference frames would lead to improved encoding; and completing motion prediction and entropy encoding for frame sequential stereoscopic video in response to ordering of reference frames including reordered reference frames; wherein said reordering of selected reference frames increases the number of macroblocks which are skipped, and not encoded, into the frame sequential stereoscopic video output.

17. A method as recited in embodiment 16, wherein said entropy encoding comprises performing decorrelating blocks using transforms, quantizing the transform coefficients, and encoding the transforms into the output data.

18. A method as recited in embodiment 16, further comprising using dual I-frames toward reducing quality variance of the sequential stereoscopic video output.

19. A method as recited in embodiment 16, wherein a frame is encoded with both reordered and original ordered reference frames and the statistics of each compared to determine if the reference frame should be reordered in the encoding.

20. A method as recited in embodiment 16, further comprising encoding information about reference frame sequencing within the sequential stereoscopic video output allowing a decoder to properly decode the reference frames.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. An apparatus for encoding frame sequential stereoscopic video, comprising:
a computer configured for encoding first and second image sequences into a frame sequential stereoscopic video output;
a memory coupled to said computer; and
programming stored on said memory and executable on said computer for performing steps comprising:
dividing images into blocks;
reordering selected reference frames in response to determining if reordering reference frames would lead to improved encoding; and
completing motion prediction and entropy encoding for frame sequential stereoscopic video in response to ordering of reference frames including reordered reference frames.

2. An apparatus as recited in claim 1, wherein said entropy encoding comprises decorrelating blocks using transforms, quantizing the transform coefficients, and encoding the transforms into the output data.

3. An apparatus as recited in claim 1, wherein said programming performs the step comprising determining if a scene cut has taken place and setting the frame to an I-type.

4. An apparatus as recited in claim 1, wherein said programming performs the step comprising using dual I-frames toward reducing quality variance of the sequential stereoscopic video output.

5. An apparatus as recited in claim 1, wherein a frame is encoded with both reordered and originally ordered reference frames and the statistics of each compared to determine if the reference frame should be reordered in the encoding.

6. An apparatus as recited in claim 1, wherein said encoding apparatus comprises an encoder adapted for encoding video according to the AVC or H.264 encoding standard.

7. An apparatus as recited in claim 1, wherein said reordering selected reference frames in said apparatus increases the number of macroblocks which are skipped, and not encoded, into the frame sequential stereoscopic video output.

8. An apparatus as recited in claim 1, wherein said reordering selected reference frames in said apparatus decreases the number of macroblocks which are referenced per frame.

9. An apparatus as recited in claim 1, wherein said first and second image sequences are captured in response to image capture from a left side imager and a right side imager.

10. An apparatus as recited in claim 1, wherein said programming performs the step comprising encoding information about reference frame sequencing within the sequential stereoscopic video output allowing a decoder to properly decode the reference frames.

11. An apparatus for encoding frame sequential stereoscopic video, comprising:
a computer configured for encoding first and second image sequences into a frame sequential stereoscopic video output;
a memory coupled to said computer; and
programming stored on said memory and executable on said computer for performing steps comprising:
dividing images into blocks;
reordering selected reference frames in response to determining if reordering reference frames would lead to improved encoding in response to increasing the number of skipped macroblocks, increasing PSNR, and/or fitting bit cost constraints;
completing motion prediction and entropy encoding for frame sequential stereoscopic video in response to ordering of reference frames including reordered reference frames, by uncorrelated blocks using transforms, quantizing the transform coefficients, and encoding the transforms into the output data; and
encoding side-information about reference frame sequencing within the sequential stereoscopic video output allowing a decoder to properly decode the reference frames.

12. An apparatus as recited in claim 11, wherein said programming performs the step comprising using dual I-frames toward reducing quality variance of the sequential stereoscopic video output.

13. An apparatus as recited in claim 11, wherein a frame is encoded with both reordered and reference frames as originally ordered and the statistics of each compared to determine if the reference frame should be reordered in the encoding.

14. An apparatus as recited in claim 11, wherein said encoding apparatus comprises an encoder adapted for encoding video according to the AVC or H.264 encoding standard.

15. An apparatus as recited in claim 11, wherein said reordering selected reference frames in said apparatus increases the number of macroblocks which are skipped, and not encoded, into the frame sequential stereoscopic video output, and/or decreases the number of macroblocks which are referenced per frame.

16. A method of encoding frame sequential stereoscopic video within a video encoder circuit configured for encoding first and second image sequences into a frame sequential stereoscopic video output, comprising:
dividing images into blocks;
reordering selected reference frames in response to determining if reordering reference frames would lead to improved encoding; and
completing motion prediction and entropy encoding for frame sequential stereoscopic video in response to ordering of reference frames including reordered reference frames;
wherein said reordering of selected reference frames increases the number of macroblocks which are skipped, and not encoded, into the frame sequential stereoscopic video output.

17. A method as recited in claim 16, wherein said entropy encoding comprises performing decorrelating blocks using transforms, quantizing the transform coefficients, and encoding the transforms into the output data.

18. A method as recited in claim 16, further comprising using dual I-frames toward reducing quality variance of the sequential stereoscopic video output.

19. A method as recited in claim 16, wherein a frame is encoded with both reordered and original ordered reference frames and the statistics of each compared to determine if the reference frame should be reordered in the encoding.

20. A method as recited in claim 16, further comprising encoding information about reference frame sequencing within the sequential stereoscopic video output allowing a decoder to properly decode the reference frames.
